(19) United States
(12) Patent Application Publication
(10) Pub. No.: US 2008/0115185 A1
(43) Pub. Date: May 15, 2008

(54) Dynamic modification of video properties

(75) Inventors: Jingyu Qiu, Issaquah, WA (US); Regis J. Crinon, Camas, WA (US); Timothy Mark Moore, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/591,297

(22) Filed: Oct. 31, 2006

(51) Int. Cl. H04N 7/173

(52) U.S. Cl. 725/118; 725/119; 725/115

(57) ABSTRACT

Aspects of the present invention are directed at improving the quality of a video stream that is transmitted between networked computers. In accordance with one embodiment, a method is provided that dynamically modifies the properties of a video stream based on network conditions. In this regard, the method includes collecting quality of service data that describes the network conditions that exist when the video stream is being transmitted. Then, the amount of predicted artifact in the video stream is calculated using the collected data. In response to identifying a triggering event, the method modifies the properties of the video stream to account for the network conditions.

### BACKGROUND

Computer networks, such as the Internet, have revolutionized the way in which people obtain information. For example, modern computer networks support the use of e-mail communications for transmitting information between people who have access to the computer network. Increasingly, systems are being developed that enable the exchange of data over a network that has a real-time component. For example, a video stream may be transmitted between communicatively connected computers such that network conditions may affect how the information is presented to the user.

Those skilled in the art and others will recognize that data is transmitted over a computer network in packets. Unfortunately, packet loss occurs when one or more packets being transmitted over the computer network fail to reach their destination. Packet loss may be caused by a number of factors, including, but not limited to, an over utilized network, signal degradation, packets being corrupted by faulty hardware, and the like. When packet loss occurs, performance issues may become noticeable to the user. For example, in the context of a video stream, packet loss may result in “artifact” or distortions that are visible in a sequence of video frames.

The amount of artifact and other distortions in the video stream is one of the factors that has the strongest influence on overall visual quality. However, one deficiency with existing systems is an inability to objectively measure the amount of predicted artifact in a video stream. Developers could use information obtained by objectively measuring artifact to make informed decisions regarding the various tradeoffs needed to deliver quality video services. Moreover, those skilled in the art and others will recognize that when packet loss occurs, various error recovery techniques may be implemented to prevent degradation of the video stream. However, these error recovery techniques have their own trade-offs with regard to consuming network resources and affecting video quality. When modifications to the properties of a video stream are made, it would be beneficial to be able to objectively measure how these modifications will affect the quality of video services. In this regard, it would also be beneficial to objectively measure how error recovery techniques will impact the quality of a video stream to determine, among other things, whether the error recovery should be performed.

Another deficiency with existing systems is an inability to objectively measure the amount of artifact in the video stream and dynamically modify the encoding process based on the observed data. For example, during the transmission of a video stream, packet loss rates or other network conditions may change. However, with existing systems, encoders that compress frames in a video stream may not be able to identify how to modify the properties of the video stream to account for the network conditions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at improving the quality of a video stream that is transmitted between networked computers. In accordance with one embodiment, a method is provided that dynamically modifies the properties of the video stream based on network conditions. In this regard, the method includes collecting quality of service data describing the network conditions that exist when a video stream is being transmitted. Then, the amount of predicted artifact in the video stream is calculated using the collected data. In response to identifying a triggering event, the method may modify the properties of the video stream to more accurately account for the network conditions.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial depiction of a networking environment suitable to illustrate components that may be used to transmit a video stream in accordance with one embodiment of the present invention;

FIGS. 2A and 2B are pictorial depictions of an exemplary sequence of frames suitable to illustrate the encoding of a video stream for transmission over the networking environment depicted in FIG. 1;

FIG. 3 is a block diagram of a chart that describes video quality given certain network conditions;

FIGS. 4A and 4B are block diagrams of a chart that describes video quality given certain network conditions;

FIG. 5 is a block diagram of a chart that describes video quality given certain network conditions;

FIG. 6 is a block diagram of a chart that describes video quality given certain network conditions;

FIG. 7 is a pictorial depiction of another networking environment that maintains attributes suitable to implement aspects of the present invention;

FIG. 8 is a pictorial depiction of the networking environment depicted in FIG. 7 illustrating the transmission of a video stream between networked devices in accordance with one embodiment; and

FIG. 9 is a flow diagram illustrative of an exemplary routine for modifying the properties of a video stream in accordance with another embodiment of the present invention.

### DETAILED DESCRIPTION

The present invention may be described in the general context of computer-executable instructions, such as program modules, being executed by computers. Generally described, program modules include routines, programs, widgets, objects, components, data structures, and the like that perform particular tasks or implement particular abstract data types.

Although the present invention will be described primarily in the context of systems and methods that modify the properties of a video stream based on observed network conditions, those skilled in the art and others will appreciate the present invention is also applicable in other contexts. In any event, the following description first provides a general overview of a system in which aspects of the present invention may be implemented. Then, an exemplary routine that dynamically modifies the properties of a video stream based on observed network conditions is described. The examples provided herein are not intended to be exhaustive or to limit the invention to the precise forms disclosed. Similarly, any steps described herein may be interchangeable with other steps or combinations of steps in order to achieve the same result. Accordingly, the embodiments of the present invention described below should be construed as illustrative in nature and not limiting.

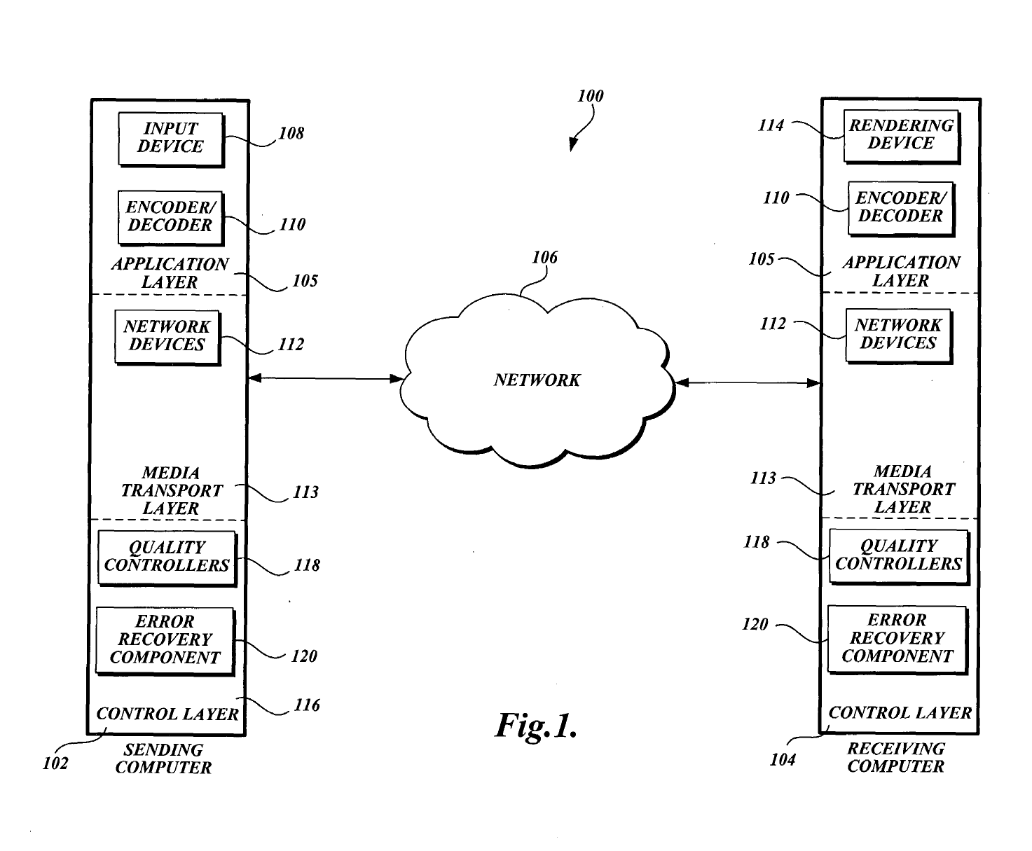

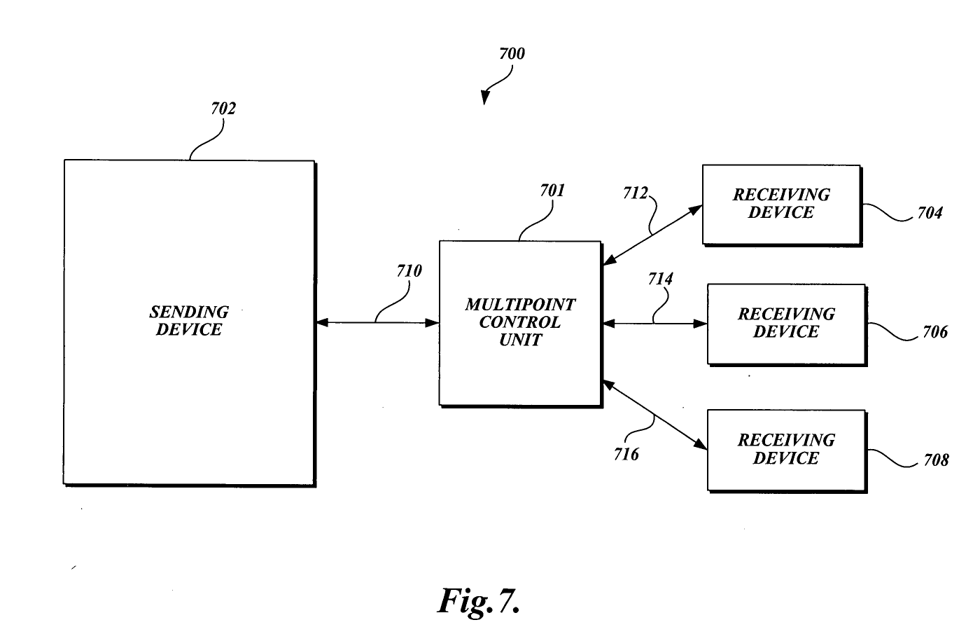

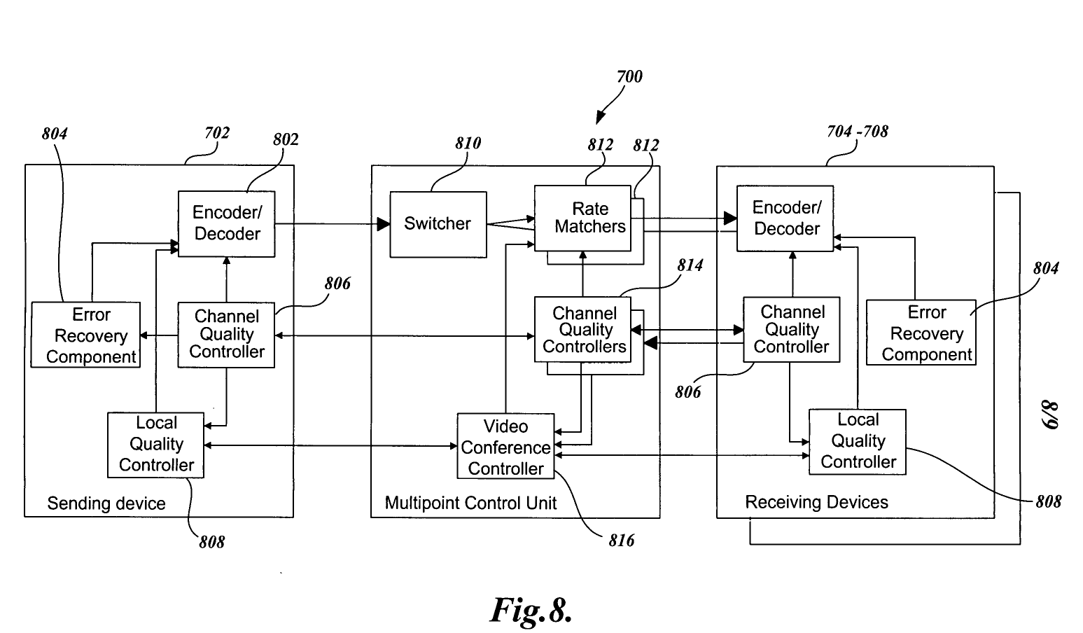

Now with reference to FIG. 1, interactions between components used to communicate a video stream in a networking environment 100 will be described. As illustrated in FIG. 1, the networking environment 100 includes a sending computer 102 and a receiving computer 104 that are communicatively connected in a peer-to-peer network connection. In this regard, the sending computer 102 and the receiving computer 104 communicate data over the network 106. As described in further detail below with reference to FIGS. 7 and 8, the sending computer 102 may be a network endpoint that is associated with a user. Alternatively, the sending computer 102 may serve as a node in the networking environment 100 by relaying a video stream to the receiving computer 104. Those skilled in the art and others will recognize that the network 106 may be implemented as a local area network (“LAN”), wide area network (“WAN”) such as the global network commonly known as the Internet or World Wide Web (“WWW”), cellular network, IEEE 802.11, Bluetooth wireless networks, and the like.

In the embodiment illustrated in FIG. 1, a video stream is input into the sending computer 102 from the application layer 105 using the input device 108. The input device 108 may be any device that is capable of capturing a stream of images including, but certainly not limited to, a video camera, digital camera, cellular telephone, and the like. When the video stream is input into the sending computer 104, the encoder/decoder 110 is used to compress frames of the video stream. Those skilled in the art and others will recognize that the encoder/decoder 110 performs compression in a way that reduces the redundancy of image data within a sequence of frames. Since the video stream typically includes a sequence of frames which differ from one another only incrementally, significant compression is realized by encoding at least some frames based on differences with other frames. As described in further detail below, frames in a video stream may be encoded as “I-frames,” “P-frames,” “SP-frames” and “B-frames;” although other frame types (e.g., unidirectional B-frames, and the like) are increasingly utilized. However, when errors cause packet loss or other video degradation, encoding a video stream into compressed frames may perpetuate errors, thereby resulting in artifact persisting over multiple frames.

Once the encoder/decoder 110 compresses the video stream by reducing redundancy of image data within a sequence of frames, the network devices 112 and associated media transport layer 113 components (not illustrated) may be used to transmit the video stream. In this regard, frames of video data may be packetized and transmitted in accordance with standards dictated by the real-time transport protocol (“RTP”). Those skilled in the art and others will recognize that RTP is one exemplary Internet standard protocol that may be used for the transport of real-time data. In any event, when the video stream is received, the encoder/decoder 110 on the receiving computer 104 causes the stream to be decoded and presented to a user on the rendering device 114. In this regard, the rendering device 114 may be any device that is capable of presenting image data including, but not limited to, a computer display (e.g., CRT or LCD screen), a television, monitor, printer, etc.

The control layer 116 provides quality of service support for applications with real-time properties such as applications that support the transmission of a video stream. In this regard, the quality controllers 118 provide quality of service feedback by gathering statistics associated with a video stream including, but not limited to, packet loss rates, round trip times, and the like. By way of example only, the data gathered by the quality controllers 118 may be used by the error recovery component 120 to identify packets that will be re-transmitted when error recovery is performed. In this regard, data that adheres to the real-time transport protocol may be periodically transmitted between users that are exchanging a video stream. The components of the control layer 116 may be used to modify properties of the video stream based on collected quality of service information. Those skilled in the art and others will recognize that, while specific components and protocols have been described with reference to FIG. 1, these specific examples should be construed as exemplary, as aspects of the present invention may be implemented using different components and/or protocols. For example, while the description provided with reference to FIG. 1 uses RTP to transmit a video stream between networked computers and RTCP to provide control information, other protocols may be utilized without departing from the scope of the claimed subject matter.

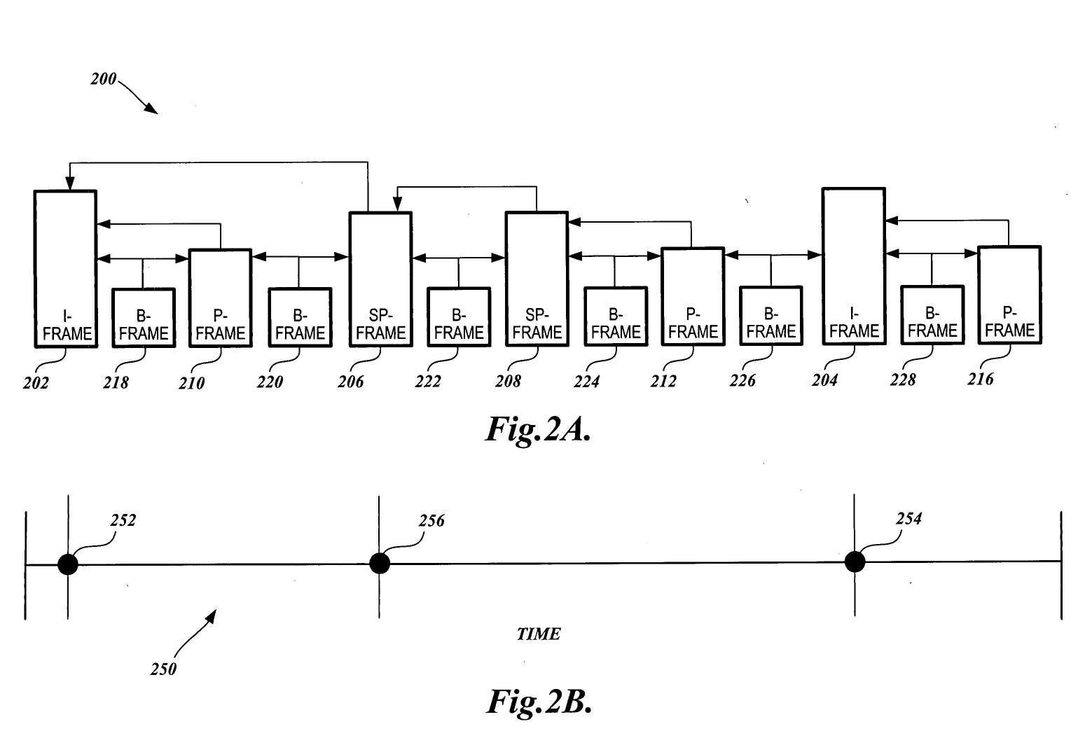

Now with reference to FIGS. 2A and 2B, an exemplary sequence of frames 200 in a video stream will be described. As mentioned previously with reference to FIG. 1, an encoder may be used to compress frames in a video stream in a way that reduces the redundancy of image data. In this regard, FIG. 2A illustrates a sequence of frames 200 that consists of the I-frames 202-204, SP-frames 206-208, P-frames 210-216, and B-frames 218-228. The I-frames 202-204 are standalone in that I-frames do not reference other frame types and may be used to present a complete image. As illustrated in FIG. 2A, the I-frames 202-204 serve as predictive references, either directly or indirectly, for the SP-frames 206-208, P-frames 210-216, and B-frames 218-228. In this regard, the SP-frames 206-208 are predictive in that the frames are encoded with reference to the nearest previous I-frame or other SP-frame. Similarly, the P-frames 210-216 are also predictive in that these frames reference an earlier frame which may be the nearest previous I-frame or SP-frame. As further illustrated in FIG. 2, the B-frames 218-228 are encoded using a technique known as bidirectional prediction in that image data is encoded with reference to both a previous and subsequent frame.

The amount of data in each frame is visually depicted in FIG. 2A with I-frames 202-204 containing the largest amount of data and SP-frames 206-208, P-frames 210-216, and B-frames 218-228 each providing successively larger amounts of compression. As used herein, the term “compression mode” refers to the state of an encoder when a particular frame type (e.g. I-frame, SP-frame, P-frame, B-frame, etc.) is encoded for transmission over a network connection. Those skilled in the art in others will recognize that an encoder may be configured to support different compression modes for the purpose of creating different frame types. While encoding the sequence of frames 200 into various frame types reduces the amount of data that is transmitted, compression of image data may perpetuate errors. In this regard, the I-frame 202 may be transmitted between communicatively connected computers in a set of packets. However, if any of the packets in the I-frame 202 are lost in transit, the I-frame 202 is not the only frame affected by the error. Instead, the error may persist to other frames that directly or indirectly reference the I-frame 202. For example, as depicted in the timeline 250 of FIG. 2B, when the I-frame 202 experiences an error, at event 252, the error persists until event 254 when the subsequent I-frame 204 is received. In this instance, frames received between events 252 and 254 experience a degradation in quality, typically in the form of artifact.

Similar to the description provided above, when a packet associated with an SP-frame is lost, the error may persist to other frames. For example, as depicted in the timeline 250, when the SP-frame 206 experiences packet loss, at event 256, the error persists until event 254 when the next I-frame 204 is received. Since fewer dependencies exist with regard to SP-frames than I-frames, the impact of packet loss is also less. When a P-frame experiences packet loss, only the B-frames and other P-frames which reference the P-frame that experienced packet loss are impacted by the error. Finally, errors in B-frames do not persist since B-frames are not referenced by other frame types.

As described above with reference to FIGS. 2A and 2B, encoding a video stream may cause artifact to persist as dependencies between frames exist. In this regard, Equation 1 contains one mathematical model that is based on general statistical assumptions which may be used to calculate the predicted artifact when error recovery is not being performed. In this regard, Equation 1 provides a formula for calculating the predicted artifact when a video stream consists of the four frame types described above with reference to FIGS. 2A-B. In this context, the term “predicted artifact” generally refers to the number of frames in a group of pictures that are affected by packet loss. As described in further detail below, calculating the predicted artifact using the formula in Equation 1 may be used to determine how and whether aspects of the present invention modify the properties of a video stream.

$$Predicted Artifact = {P}_{I} {N}_{GOP} + \frac{( 1 - {P}_{I} ) {N}_{GOP}}{( {N}_{SP} + 1 )} * \frac{{N}_{SP} {P}_{SP} - ( 1 - {P}_{SP} ) * ( 1 - {( 1 - {P}_{SP} )}^{{N}_{sp}} )}{{P}_{SP}} + \frac{( 1 - {P}_{I} )}{{P}_{SP}} * [ 1 - ( 1 - {P}_{SP} ) ( {N}_{SP} + 1 ) ] * \frac{{N}_{GOP}}{( {N}_{SP} + 1 ) ( {N}_{P}^{G} + 1 )} \frac{{N}_{P}^{G} {P}_{P} - ( 1 - {P}_{P} ) * ( 1 - {( 1 - {P}_{P} )}^{{N}_{P}^{G}} )}{{P}_{P}} + {\frac{( 1 - {P}_{I} ) {N}_{B} {P}_{B}}{{P}_{SP}} [ 1 - ( 1 - {P}_{SP} ) ( {N}_{SP} + 1 ) ]}^{[ 1 - ( 1 - {P}_{P} ) ( {N}_{P}^{G} + 1 ) ]} \qquad ( Equation 1 )$$

### Wherein:

N_{B}=number of B-frames in one Group of Pictures;

N_{GOP}=number of frames in a Group of Pictures;

N_{P}^{G}=number of P-frames between consecutive I-I, I-SP, SP-SP, or SP-I frames;

N_{SP}=number of SP-frames in one Group of Pictures;

P_{B}=B-frame loss probability;

P_{I}=I-frame loss probability;

P_{P}=P-frame loss probability; and

P_{SP}=SP-frame loss probability.

Similar to Equation 1, Equation 2 contains a mathematical model that may be used to calculate the predicted artifact. However, in this instance, the mathematical model depicted in Equation 2 applies when error recovery is being performed. For example, error recovery may be performed when computers that are transmitting a video stream are configured to re-send packets of a video frame that are corrupted in transit. In this regard, Equation 1 provides a formula for calculating the predicted artifact in a principal video stream that is initially transmitted between computers when a video stream consists of the four frame types described above with reference to FIG. 2A-B. Similar to the description provided with Equation 1, Equation 2 may be used to determine how and whether aspects of the present invention modify the properties of a video stream. However, Equation 2 applies when error recovery is being performed.

$$Predicted Artifact = {P}_{I} {P}_{I} ( RTT + 1 ) + {P}_{SP} {P}_{SP} ( RTT + 1 ) + {P}_{P} {P}_{P} ( RTT + 1 ) + {P}_{B} {P}_{B} \qquad ( Equation 2 )$$

### Wherein:

P_{I}=I-frame loss probability;

P_{SP}=SP-frame loss probability.

P_{P}=P-frame loss probability;

P_{B}=B-frame loss probability; and

RTT=round trip time.

Those skilled in the art and others will recognize that the mathematical models provided above with regard to Equations 1 and 2 should be construed as exemplary and not limiting. For example, these mathematical models assume that a video stream consists of I-frames, P-frames, SP-frames, and B-frames. However, as mentioned previously, a video stream may consist of fewer or additional frame types and/or a different set of frame types than those described above. In these instances, variations on the mathematical models provided above may be used to calculate the predicted artifact in a video stream. Moreover, Equations 1 and 2 are described in the context of calculating the amount of predicted artifact. The “artifact percentage” from a video stream may be calculated using the mathematical models described above by dividing the predicted artifact with the number of frames in a Group of Pictures (“GOP”).

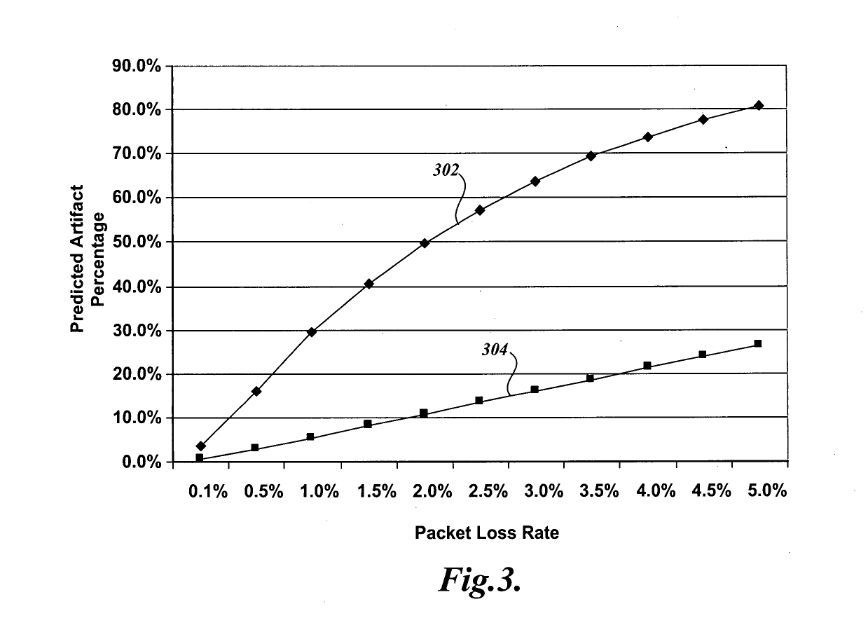

With reference now to FIGS. 3-6, distributions that describe the amount of predicted artifact in a video stream given various network conditions will be described. In an illustrative embodiment, the distributions depicted in FIGS. 3-6 may be utilized to identify instances when properties of a video stream may be modified to more accurately reflect network conditions. As illustrated in FIG. 3, the x-axis corresponds to a packet loss rate and the y-axis corresponds to the predicted artifact percentage for a group of pictures (“GOP”) in the principal video stream that is initially transmitted between the computers. In this regard, FIG. 3 depicts the distribution 302 which illustrates the amount of predicted artifact percentage for the group of pictures at different packet loss rates when error recovery is not being performed. Similarly, distribution 304 illustrates the amount of predicted artifact at different packet loss rates when error recovery is being performed.

As FIG. 3 illustrates, the artifact percentage increases for both distributions 302 and 304 as packet loss rates increase. Moreover, when error recovery is not being performed, the predicted artifact percentage is substantially greater for all packet loss rates when compared to instances when error recovery is being performed. As mentioned previously above, packet loss rates may change due to various network conditions, even during the same network session. In this regard, the quality controllers 118 (FIG. 1) provide quality of service feedback by gathering statistics associated with the network session that includes packet loss rates. When the packet loss rates are accessed from the quality controllers 118, the distributions 302 and 304 may be used to identify the predicted artifact for a video stream.

In accordance with one embodiment, ranges of predicted artifact associated with the distributions 302-304 may be used to set the properties of a video stream. For example, when error recovery is being performed and the artifact percentage represented in the distribution 304 is identified as being less than ten (10) percent, a video stream may be transmitted in accordance with a first set of properties. The properties of the video stream potentially modified given the range of artifact percentage may include, but are not limited to, the distribution of frame types (e.g., the percentage and frequency of I-frames, SP-frames, P-frames, B-frames), the frame rate, the size of frames and packets, the application of redundancy in channel coding including the extent in which forward error correction (“FEC”) is applied for each frame type, etc. In this regard, by objectively measuring the predicted artifact in a video stream, more informed decisions may be made regarding how the video stream should be transmitted. For example, as the amount of predicted artifact increases, the properties of the video stream may be modified to include a higher percentage of B-frames, thereby improving video quality at higher packet loss rates. Moreover, if the artifact percentage represented in the distribution 304 is identified as corresponding to a different range, the video stream may be transmitted in accordance with another set of video properties.

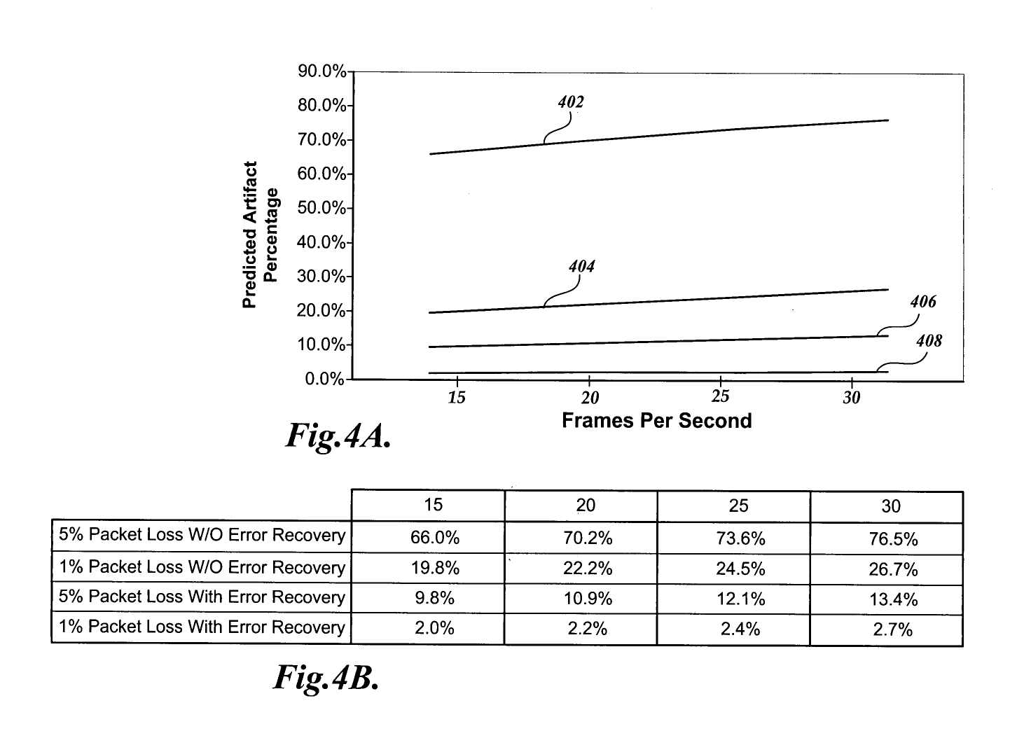

FIG. 4A depicts the distributions 402, 404, 406, and 408 which illustrate the amount of predicted artifact percentage at different frame and packet loss rates. As illustrated in FIG. 4A, the x-axis corresponds to a frame rate of between fifteen (15) and thirty (30) per second and the y-axis corresponds to the predicted artifact percentage at the different frame rates. More specifically, the distribution 402 illustrates the amount of predicted artifact percentage between fifteen (15) and thirty (30) frames per second when a network session is experiencing a packet loss rate of five (5) percent and error recovery is not being performed. The distribution 404 illustrates the amount of predicted artifact percentage between fifteen (15) and thirty (30) frames per second when a network session is experiencing a packet loss rate of one (1) percent and error recovery is not being performed. The distribution 406 illustrates the amount of predicted artifact percentage in the principal video stream between fifteen (15) and thirty (30) frames per second when a network session is experiencing a packet loss rate of five (5) percent and error recovery is being performed. The distribution 408 illustrates the amount of predicted artifact percentage between fifteen (15) and thirty (30) frames per second when a network connection is experiencing a packet loss rate of one (1) percent and error recovery is being performed. The exact value of the predicted artifact for the different scenarios visually depicted in FIG. 4A is represented numerically in the table presented in FIG. 4B. As FIGS. 4A and 4B illustrate, an increase in frame rates may actually increase the predicted artifact percentage and reduce video quality when a video stream is encoded into various frame types.

In accordance with one embodiment, ranges of predicted artifact obtained using the distributions 402-408 may be established to set properties of a video stream. For example, in some instances, a content provider guarantees a certain quality of service for a video stream. Based on information represented in the distributions 402-408, the predicted artifact percentage at different frame rates, packet loss rates, and other network properties may be identified. By identifying the predicted artifact percentage, the frame rate may be adjusted so that the quality of service guarantee is satisfied. In this regard, the frame rate may be reduced in order to produce a corresponding reduction in artifact.

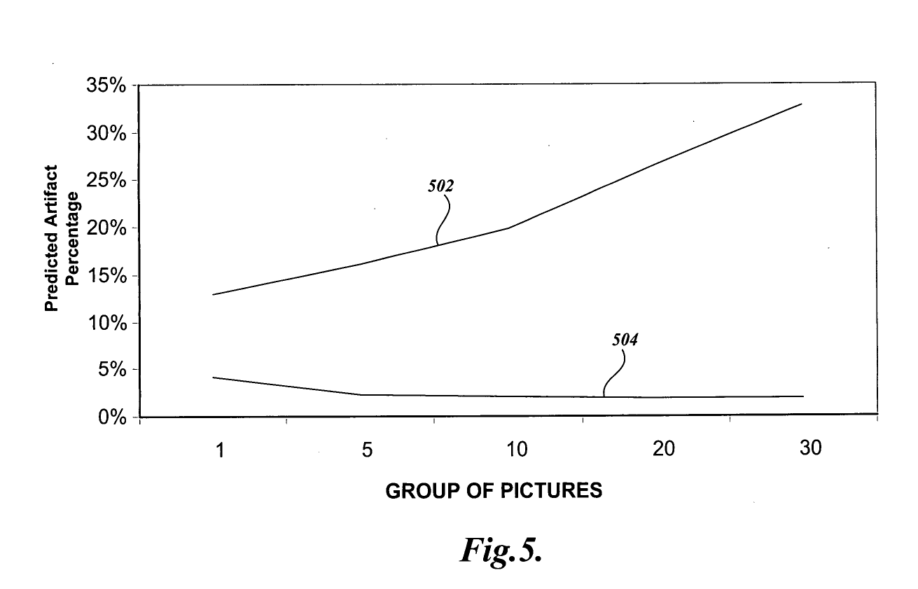

FIG. 5 depicts the distributions 502 and 504 which illustrate the amount of predicted artifact percentage at different group of picture (“GOP”) values when the network is experiencing a one (1) percent rate of packet loss. Those skilled in the art and others will recognize that GOP refers to a sequence of frames that begins with a first standalone frame (e.g., I-frame) and ends at the next standalone frame. As illustrated in FIG. 5, the x-axis corresponds to GOP values in a video stream and the y-axis corresponds to the predicted artifact percentage at the various GOP values. In this regard, the distribution 502 illustrates the amount of predicted artifact percentage for different GOP values when error recovery is not being performed. Similarly distribution 504 illustrates the amount of predicted artifact percentage when error recovery is being performed for the principal video stream that is initially transmitted between the computers. As distribution 502 illustrates, higher GOP values cause a corresponding increase in artifact and a reduction in video quality when error recovery is not being performed. Conversely, when error recovery is being performed, larger GOP values result in less artifact and better video quality. Similar to the description provided above, ranges of predicted artifact obtained from the distributions 502-504 may be used to establish properties for a video stream. In this regard, when error recovery is not being performed, the frame sequence may be encoded with lower GOP values by increasing the occurrence of I-frames. Conversely, when error recovery is being performed, the frame sequence may be encoded with fewer I-frames and a higher GOP value.

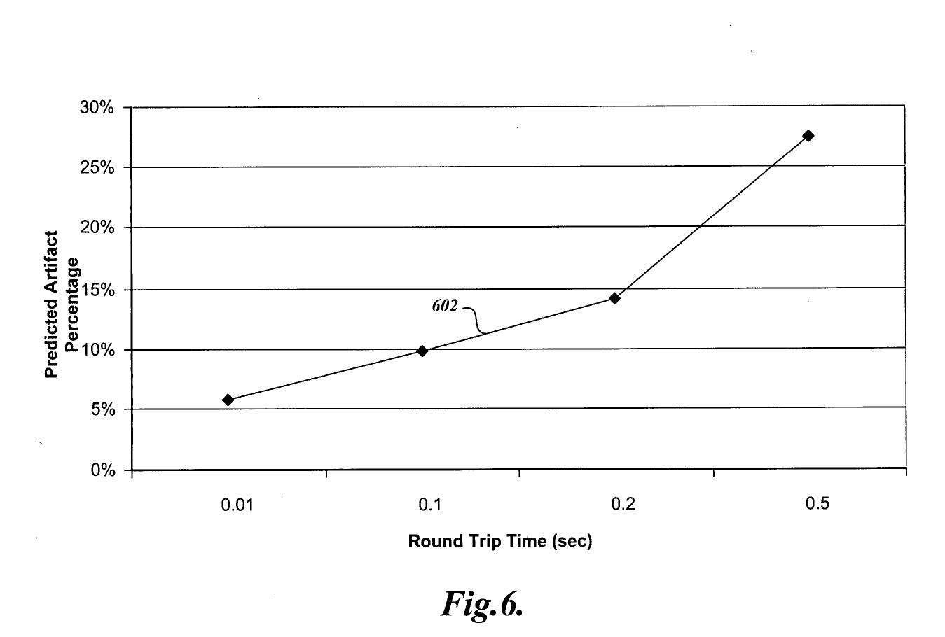

FIG. 6 depicts the distribution 602 which illustrates the amount of predicted artifact percentage at different round-trip times (“RTTs”) when error recovery is being performed. Those skilled in the art and others will recognize that a round trip time refers to the time required for a network communication to travel from a sending device to a receiving device and back. Since error recovery may be performed by sending a message that indicates a packet in a video stream was not received, the effectiveness of error recovery depends on the round-trip time required to obtain lost packets. Moreover, those skilled in the art and others will recognize that the RTT between communicatively corrected computers impacts the number of packets and their associated video frames that can be re-transmitted. As illustrated in FIG. 6, the RTT between communicatively connected computers is depicted on the x-axis. The y-axis corresponds to the predicted artifact percentage at various round-trip times when a network is experiencing packet loss at five (5) percent. In this regard, the distribution 602 illustrates that the amount of predicted artifact increases as the RTT increases when error recovery is being performed. Moreover, the distribution 602 illustrates that above certain threshold levels, the predicted artifact increases at a faster rate than below the threshold level. Similar to the description provided above, ranges of predicted artifact obtained from the distribution 602 may be used to establish properties of a video stream. For example, when the network experiences 5% packet loss and the round-trip time is identified as being greater than two-hundred (200) milliseconds (0.2 seconds), forward error correction that adds redundancy in channel coding by potentially causing the same packet to be sent multiple times may be implemented to reduce artifact. In this regard, different strengths of redundancy in channel coding may be applied and modified for each frame type in a video stream. Moreover, the distribution of frame types and other video properties may also be modified based on thresholds of predicted artifact percentage identified from the distribution 602.

The examples provided with regard to FIGS. 3-6 should be construed as exemplary and not limiting. In this regard, FIGS. 3-6 illustrate distributions that describe the percentage of predicted artifact in a video stream given various network conditions. While exemplary network conditions have been provided, aspects of the present invention may be used to modify the properties of a video stream in other contexts without departing from the scope of the claimed subject matter.

Increasingly, a video stream is transmitted over multiple network links. For example, a multi-point control unit is a device that supports a video conference between multiple users. In this regard, FIG. 7 illustrates a networking environment 700 that includes a multi-point control unit 701, a plurality of video conference endpoints including the sending device 702 and the receiving devices 704-708. Moreover, the networking environment 700 includes a peer-to-peer network connection 710 between the sending device 702 and the multi-point control unit 701 as well as a plurality of downstream network connections 712-716 between the multi-point control unit 701 and the receiving devices 704-708. Generally described, the multi-point control unit 701 collects information about the capabilities of devices that will participate in a video conference. Based on the information collected, properties of a video stream between the network endpoints may be established.

Now with reference to FIG. 8, components of the multi-point control unit 701, the sending device 702, and the receiving devices 704-708 depicted in FIG. 7 will be described in further detail. Similar to the description provided above with reference to FIG. 1, the sending device 702 and receiving devices 704-708 include an encoder/decoder 802, the error recovery components 804, the channel quality controllers 806, and the local quality controllers 808. In this exemplary embodiment, the multi-point control unit 701 includes the switcher 810, the rate matchers 812, the channel quality controllers 814, and the video conference controller 816.

In this exemplary embodiment, a video stream encoded by the encoder/decoder 802 on the sending device 702 is transmitted to the switcher 810. When received, the switcher 810 routes the encoded video stream to each of the rate matchers 812. For each device that will receive the video stream, one of the rate matchers 812 applies algorithms on the encoded video stream that allows the same content to be reproduced on devices that communicate data at different bandwidths. Once the rate matchers 812 have applied the rate matching algorithms, the video stream is transmitted to the receiving devices 704-708 where the video stream may be decoded for display to the user.

Unfortunately, existing systems may set the properties of the video stream to the lowest common denominator to accommodate a device that maintains the worst connection in the networking environment 700. Moreover, transmission of a video stream using the multi-point control unit 701 may not scale to large numbers of endpoints. For example, when the sending device 702 transmits a video stream to the multi-point control unit 701, the data may be forwarded to each of the receiving devices 704-708 over the downstream network connections 712-716, respectively. When packet loss occurs on the downstream network connections 712-716, requests to re-send lost packets may be transmitted back to the sending device 702, if error recovery is being performed. However, since the sending device 702 is supporting error recovery for all of the receiving devices 704-708, the sending device 702 may be overwhelmed with requests. More generally, as the number of endpoints participating in the video conference increase, the negative consequences of performing error recovery also increases. Thus, objectively measuring video quality and setting the properties of a video stream to account for network conditions is particularly applicable in the context of a multi-point control unit that manages a video conference. However, while aspects of the present invention may be described as being implemented in the context of a multi-point control unit, those skilled in the art and others will recognize that aspects of the invention will apply in other contexts.

The channel quality controllers 814 on the multi-point control unit 701 communicate with the channel quality controllers 806 on the sending device 702 and receiving devices 704-708. In this regard, the channel quality controllers 814 monitor bandwidth, RTT, and packet loss on each of their respective communication channels. The video conference controller 816 may obtain data from each of the channel quality controllers 806 and set properties of one or more video streams. In this regard, the video conference controller 816 may communicate with the rate matchers 812 and the local quality controllers 808 to set the properties for encoding the video stream on the sending device 702. These properties may include but are not limited to, frame and data transmission rates, GOP values, the distribution of frame types, error recovery, redundancy in channel coding, frame and/or packet size, and the like.

Aspects of the present invention may be implemented in the video conference controller 816 to tune the properties at which video data is transmitted between sending and receiving devices. In accordance with one embodiment, the properties of a video stream are modified dynamically based on observed network conditions. For example, the video conference controller 816 may obtain data from each of the respective channel quality controllers 806 that describes observed network conditions. Then, calculations may be performed to determine whether a reduction of artifact in the video stream may be achieved. For example, using the information described with reference to FIGS. 3-6, a determination may be made regarding whether a different set of video properties will reduce the amount of artifact in a video stream. In this regard, the video conference controller 816 may communicate with the rate matchers 812 and local quality controllers 808 to set the properties of one or more video streams.

In accordance with one embodiment, the video conference controller 816 communicates with the rate matcher 812 for the purpose of dynamically modifying the properties of the video stream that is transmitted from the sending device 702. To this end, data that describes the network conditions on the downstream network connections 712-714 is aggregated on the multipoint control unit 701. Then, an optimized set of video properties to encode the video stream on the sending device 702 is identified. For example, using a mathematical model described above, a set of optimized video properties that account for network conditions observed on the downstream network connections is identified. Then, aspects of the present invention cause the video stream to be encoded on the sending device 702 in accordance with the optimized set of video properties for transmission on the network connection 710. In this regard, the video conference controller 816 may communicate with the rate matchers 812 and the local quality controllers 808 to set the properties for encoding the video stream on the sending device 702.

In accordance with another embodiment, the video conference controller 816 communicates with the rate matcher 812 for the purpose of dynamically modifying the properties of one or more video streams that are transmitted from the multipoint control unit 701. In this regard, data that describes the network conditions on at least one downstream network connection is obtained. For example, using a mathematical model described above, a set of optimized video properties that account for network conditions observed on the a downstream network connection is identified. Then, aspects of the present invention cause the video stream to be transcoded on the multi-point control unit 701 in accordance with the optimized set of video properties for transmission on the appropriate downstream network connection. To this end, the video conference controller 816 may communicate with the rate matchers 812 to set the properties for transcoding video streams on the multipoint control unit 701.

In yet another embodiment, aspects of the present invention aggregate data obtained from the sending and receiving devices 702-708 to improve video quality. For example, those skilled in the art and others will recognize that redundancy in channel coding may be implemented when transmitting a video stream. On one hand, redundancy in channel coding adds to the robustness for transmitting a video stream by allowing techniques such as forward error correction to be performed. On the other hand, redundancy in channel coding is associated with drawbacks that may negatively impact video quality as additional network resources are consumed to redundantly transmit data. By way of example only, aspects of the present invention may aggregate information obtained from the sending and receiving devices 702-708 to determine whether and how the sending device 702 will implement redundancy in channel coding. For example, packet loss rates observed in transmitting data to the receiving devices 704-708 may be aggregated on the multi-point control unit 701. Then, calculations are performed to determine whether redundancy in channel coding will be implemented given the tradeoff of redundantly transmitting data in a video stream. In this example, aspects of the present invention may be used to determine whether redundancy in channel coding will result in improved video quality given the observed network conditions and configuration of the network.

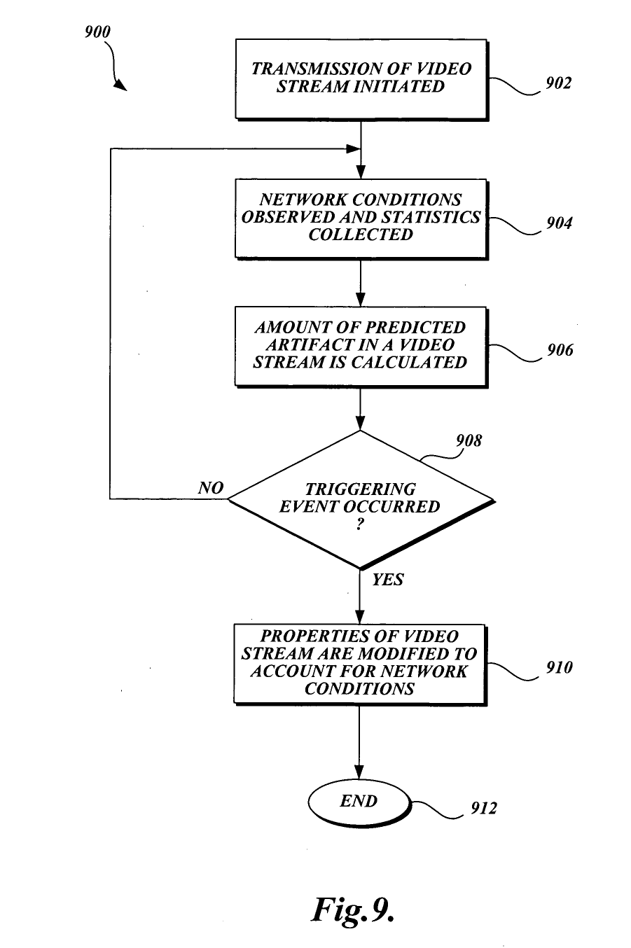

With reference now to FIG. 9, a flow diagram illustrative of a dynamic modification routine 900 will be described. Generally stated, the present invention may be used in numerous contexts to improve the quality of a video stream. In one embodiment, the invention is applied in an off-line context to set default properties for transmitting the video stream. In another embodiment, the invention is applied in a online context to dynamically modify the properties of a video stream to account for observed network conditions. While the routine 900 depicted in FIG. 9 is described as being applied in both the online and off-line contexts, those skilled in the art will recognize that this is exemplary.

At block 902, the transmission of video data is initiated using default properties. As mentioned previously, aspects of the present invention may be implemented in different types of networks, including wide and local area networks that utilize protocols developed for the Internet, wireless networks (e.g., cellular networks, IEEE 802.11, Bluetooth networks), and the like. Moreover, a video stream may be transmitted between devices and networks that maintain different configurations. For example, as mentioned previously, a sending device may merely transmit a video stream over a peer-to-peer network connection. Alternatively, in the example described above with reference to FIGS. 7 and 8, a video stream may be transmitted using a control unit that manages a video conference. In this example, the video stream is transmitted over a peer-to-peer network connection and one or more downstream network connections.

Those skilled in the art and others will recognize that the capabilities of a network affect how a video stream may be transmitted. For example, in a wireless network, the rate that data may be transmitted is typically less than the rate in a wired network. Aspects of the present invention may be applied in an off-line context to establish default properties for transmitting a video stream given the capabilities of the network. In this regard, an optimized set of properties that minimizes artifact in the video stream may be identified for each type of network and/or configuration that may be encountered. For example, the distributions depicted in FIGS. 3-6, may be used to identify the combination of properties for transmitting a video stream that will minimize artifact given the capabilities of the network and the anticipated network conditions.

Once the transmission of the video stream is initiated, the network conditions are observed and statistics that describe the network conditions are collected, at block 904. As mentioned previously, quality controllers on devices involved in the transmission of a video stream may provide quality of service feedback in the form of a set of statistics. These statistics may include packet loss rates, round-trip times, available and consumed bandwidth, or any other data that describes a network variable. In accordance with one embodiment, data transmitted in accordance with the RTCP protocol is utilized to gather statistics that describe network conditions. However, the control data may be obtained using other protocols without departing from the scope of the claimed subject matter.

As illustrated in FIG. 9, at block 906, the amount of predicted artifact in a video stream is calculated. As described above with reference to Equations 1 and 2, a mathematical model may be used to calculate the amount of predicted artifact in a video stream. Once the statistics that describe the network conditions have been collected, at block 904, the amount of predicted artifact in a video stream may be calculated. Moreover, various distributions, such as the distribution depicted in FIGS. 3-6, may be generated using the statistics that describe the network conditions.

As illustrated in FIG. 9, at decision block 908, a determination is made regarding whether a triggering event occurred. In one embodiment, triggering events are defined that will cause aspects of the present invention to modify the properties of a video stream based on observed network conditions. For example, one triggering event defined by the present invention is the predicted artifact intersecting a predefined threshold value. In this regard, if the predicted artifact increases/decreases across a predefined threshold, the properties of the video stream may be dynamically modified to account for the change in video quality. Other triggering events that may be defined include, but are not limited to changes in packet loss rates, available bandwidth, the number of participants in a video conference, and the like. While specific examples of triggering events have been provided, these examples should be construed as illustrative and not limiting, as other types of triggering events may be defined. In any event, when a triggering event is identified, the routine 900 proceeds to block 910. If a triggering event is not identified, at block 908, the routine 900 proceeds back to block 904, and blocks 904 through 908 repeat until a triggering event is identified.

At block 910, the properties of a video stream are modified to account for observed network conditions. Similar to the off-line context described above (at block 902), the distributions depicted in FIGS. 3-6 may be used to identify a set of properties that will result in a minimal amount of artifact. However, in this instance, anticipated network conditions are not utilized in identifying the quality of a video stream. Instead, actual network conditions observed “online” are utilized to perform calculations and identify a set of properties that will minimize the amount of artifact in a video stream. As mentioned previously, the properties of the video stream that may be modified by aspects of the present invention may include, but are not limited to the group of picture (“GOP”) values, distribution of frame types, redundancy in channel coding which may include forward error correction, error recovery, frame and packet size, frame rate, and the like. In this regard, the routine 900 may communicate with other software modules such as video conference controllers, rate matchers, channel quality controllers, and the like to modify the properties of the video stream, at block 910. Then the routine proceeds to block 912, where it terminates.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a networking environment that includes a sending device and a receiving device, a method of minimizing artifact in a video stream, the method comprising:
(a) establishing default properties for transmitting the video stream;
(b) initiating transmission of the video stream based on the default properties;
(c) collecting data about the network conditions that exist while the video stream is being transmitted; and
(d) modifying the default properties of the video stream to account for the network conditions.

2. The method as recited in claim 1, wherein establishing default properties for transmitting the video stream includes identifying a group of picture value, frame rate, and distribution of frame types that will minimize artifact in the video stream given the anticipated network conditions.

3. The method as recited in claim 1, wherein frames in the video stream are communicated using the real time transport protocol and wherein data that describe the network conditions are communicated in accordance with the real-time control protocol.

4. The method as recited in claim 1, wherein frames in the video stream are compressed into a plurality of different frame types and wherein modifying the default properties of the video stream includes changing the distribution of frame types.

5. The method as recited in claim 1, wherein collecting data about the network conditions that exist when the video stream is being transmitted includes identifying the packet loss rate.

6. The method as recited in claim 1, wherein collecting data about network conditions that exist while the video stream is being transmitted includes calculating the amount of predicted artifact in the video stream.

7. The method as recited in claim 6, wherein the default properties of the video stream are modified in response to the predicted artifact in the video stream intersecting a threshold value.

8. The method as recited in claim 1, wherein modifying the default properties of the video stream includes applying a different strength to the redundancy in channel coding for the video stream if a threshold increase in the packet loss rate is identified.

9. The method as recited in claim 1, wherein modifying the default properties of the video stream includes:
determining whether error recovery is being performed; and
if error recovery is being performed, increasing the group of picture value to achieve a corresponding reduction in artifact.

10. The method as recited in claim 9, further comprising, if error recovery is not being performed, decreasing the group of picture value to achieve a corresponding reduction in artifact.

11. A system for modifying the properties of a video stream based on network conditions, the system comprising:
(a) a sending device that includes at least one software component for encoding a video stream and sending the encoded video stream over an upstream network connection;
(b) one or more receiving devices that include at least one software component for receiving and decoding the video stream received on a downstream network connection; and
(c) a control unit device with one or more software components that establish default properties to transmit the video stream, collect data about the network conditions that exist when the video stream is being transmitted on the upstream and downstream network connections, and modify the default properties to account for the network conditions.

12. The system as recited in claim 11, wherein the control unit device is further configured to:
aggregate data that describes the network conditions on the downstream network connections;
use a mathematical model to identify an optimized set of video properties to encode the video stream on the sending device;
wherein the set of optimized video properties account for network conditions observed on the downstream network connections; and
cause the video stream to be encoded on the sending device in accordance with the set of optimized video properties for transmission on the upstream network connection.

13. The system as recited in claim 11, wherein the control unit device is further configured to:
obtain data that describes the network conditions on a downstream network connection;
use a mathematical model to identify an optimized set of video properties to transcode the video stream on the control unit device;
wherein the set of optimized video properties account for network conditions observed on the downstream network connection; and
cause the video stream to be transcoded in accordance with the set of optimized video properties for transmission on the downstream network connection.

14. A computer-readable medium containing computer-readable instructions which, when executed in a networking environment that includes a sending device and a receiving device, performs a method of dynamically modifying the properties of a video stream, the method comprising:
(a) collecting quality of service data about a video stream being transmitted from the sending device to the receiving device;
(b) using the quality of service data to calculate the predicted artifact in the video stream; and
(c) in response to identifying a triggering event, modifying the properties of the video stream to minimize artifact.

15. The computer-readable medium as recited in claim 14, wherein calculating the predicted artifact includes determining whether error recovery is being performed;
wherein if error recovery is being performed, modifying the properties of the video stream includes increasing the group of picture value to achieve a corresponding reduction in artifact; and
wherein if error recovery is not being performed, modifying the properties of the video stream includes decreasing the group of picture value to achieve a corresponding reduction in artifact.

16. The computer readable-medium as recited in claim 14, wherein frames in the video stream are compressed into a plurality of different frame types, and wherein modifying the properties of the video stream, includes:
identifying a compression mode used by an encoder to compress each frame type in the video stream;
using a mathematical model to identify an optimized set of video properties to encode each frame type in the video stream.

17. The computer-readable medium as recited in claim 14, wherein a triggering event that initiates a modification in the properties of the video stream is the amount of predicted artifact intersecting a threshold value.

18. The computer-readable medium as recited in claim 14, wherein a triggering event that initiates a modification in the properties of the video stream is a change in the packet loss rate.

19. The computer-readable medium as recited in claim 14, wherein modifying the default properties of the video stream includes applying a different strength of redundancy in channel coding that is dependent on the frame type.

20. The computer-readable medium as recited in claim 14, wherein the properties of the video stream that are modified include the group of picture values, frame rate, and/or distribution of frame types.
